(19) United States
(12) Patent Application Publication
(10) Pub. No.: US 2008/0044794 A1
(43) Pub. Date: Feb. 21, 2008

(54) Arrangement And System For Anchoring Of An Implant And Installation On The Implant Or Implants

(76) Inventor: Izidor Brajnovic, Goteborg (SE)

Correspondence Address: KNOBBE MARTENS OLSON & BEAR LLP, 2040 MAIN STREET, FOURTEENTH FLOOR, IRVINE, CA, 92614, US

(21) Appl. No.: 10/582,586

(22) PCT Filed: Oct. 22, 2004
(86) PCT No.: PCT/SE04/01552

§ 371 Date: Apr. 11, 2007

(30) Foreign Application Priority Data
Dec. 10, 2003 (SE) 0303308-1

(51) Int. Cl. A61C 8/00; A61C 13/12

(52) U.S. Cl. 433/174; 433/172

(57) ABSTRACT

In anchoring of an implant (5, 31) and installation on the implant or implants of a dental structure (37, 50), the respective implant is designed to be recessed in a hole by means of a tightening tool. The latter has first members which can cooperate with corresponding second members on the implant. During the anchoring of the respective implant, a sleeve (14) provided with one or more actuating members (15) is designed to b e engageable with slight clearance in relation to the upper parts of the implant. The tightening tool is designed to be applied so as to cooperate with the implant via the sleeve and, after completed anchoring of the implant and removal of the tightening tool, the sleeve can be removed with the actuating member or actuating members in order to make room for application of members included in the installation. The invention also proposes a system. for permitting the anchoring and the installation. In this way, perfect anchoring and installation of the implants is ensured.

Arrangement and system for anchoring of an implant and installation on the implant or implants.

The present invention relates, inter alia, to an arrangement for anchoring of an implant and installation on the implant or implants of a dental structure, which can be a dental bridge, tooth preparation, etc. The respective implant is designed to be recessed in a hole by means of a tightening tool which can have first members, for example sleeve, screwdriver, etc., which can cooperate with corresponding second members, for example an upwardly protruding polygonal socket, helical groove, etc., on the implant.

The invention also relates to a system for permitting said anchoring and installation.

In the anchoring of implants and the installation of replacement arrangements on these, it is already known to use various auxiliaries and methods, and reference may be made quite generally here to current techniques used today in the dental field.

In this connection, it is important that the methods used are precise so that a very close fit (for example 0.1-0.2 mm) can be achieved between the implants and installation. It is important that the method does not permit easy omission of certain stages, which can result in a poor final result and in the anchoring and/or installation work having to be repeated. The object of the present invention is to solve this problem, inter alia, and it proposes an arrangement and a system including stages which are each necessary to perform before the next stage can commence. In this connection, the need for, a simple indication that an actual stage has finished and the next stage thereafter can start is satisfied.

It is also important that the equipment and the method take account of the rapid healing tendencies which exist in implant holes which have been made in the gum. Upon installation, for example of a dental bridge, which requires several implants, there may be a not inconsiderable period of time (e.g. 0.5-1 hour) between the completed installation of the first and last implants in the arrangement, during which period of time the healing process can start and progress to some extent. Unless special measures are taken, this means, for example on account of stages being omitted, that problems arise in the subsequent installation. The patient may be subjected to discomfort and fluid may accumulate from gum and dentine in connection with the hole and the implant. The invention aims to solve this problem too.

Upon anchoring and installation, there is also a need to prevent bacterial accumulation at the contact surfaces of the implant, which bacterial accumulation must also be prevented during said period of time. The invention solves this problem too.

That which can principally be regarded as characterizing an arrangement according to the invention is that, during the anchoring of the respective implant, a sleeve provided with one or more actuating members is designed to be engageable with slight clearance in relation to the upper parts or outer surface of the implant with the aid of said actuating member or actuating members. In addition, the invention is characterized in that the tightening tool is designed to be applied so as to cooperate with the implant via the sleeve, and, after completed anchoring of the implant and removal of the tightening tool, the sleeve can be removed with the actuating member or actuating members in order to make room for application of members included in the installation.

In further developments of the inventive concept, the sleeve, with the aid of its actuating member or actuating members, can also be removed after a period of time, for example up to 3 hours, has elapsed since completion of the anchoring function. The clearance which the sleeve has in relation to the upper parts of the implant lies in the range of 0.1-0.2 mm. The actuating member or actuating members can include grip parts projecting outward from the sleeve. The actuating member or actuating members can, in addition to serving as manual actuating member or members, also function as an indicator or indicators showing that it is necessary to apply the sleeve before the installation and that it is necessary to remove the sleeve after anchoring. Further embodiments are set out in the attached dependent claims concerning the arrangement.

That which can principally be regarded as characterizing a system according to the invention is that identification equipment is arranged to identify a treatment situation on a patient and transfer information dependent on the identified situation to a computer appliance. This in turn is arranged to determine, as a function of the received information, the structure of the dental construction together with the identified situation. Further characteristics are to use the system to select a sleeve which is provided with one or more actuating members when anchoring a respective implant and which can be engaged with slight clearance over upper parts of the implant with the aid of said actuating member or actuating members. In addition, the tightening tool is to be designed for cooperation with the implant via the sleeve, and the sleeve is arranged to be removed with the actuating member or actuating members upon completed anchoring of the implant in order to leave room for application of members included in the installation.

By means of what is proposed above, advantages are afforded in that effective methods and arrangements are obtained for forming implant holes, anchoring implants in the holes and installing a dental structure/dental bridge. The sleeve with associated actuating member operates with different functions which ensure effective treatment and adaptation between the dental structure and the implant. In addition, accumulation of fluids and of bacteria at exposed surfaces of the implant are avoided, and the installation can in this way be made substantially free of bacteria. The sleeve with actuating members can also function as an indicator and guide for the tightening tool. The sleeve is easy to apply and remove by virtue of the actuating member(s).

A presently proposed embodiment of an arrangement and a system having the features according to the invention will be described below with reference to the attached drawings, in which

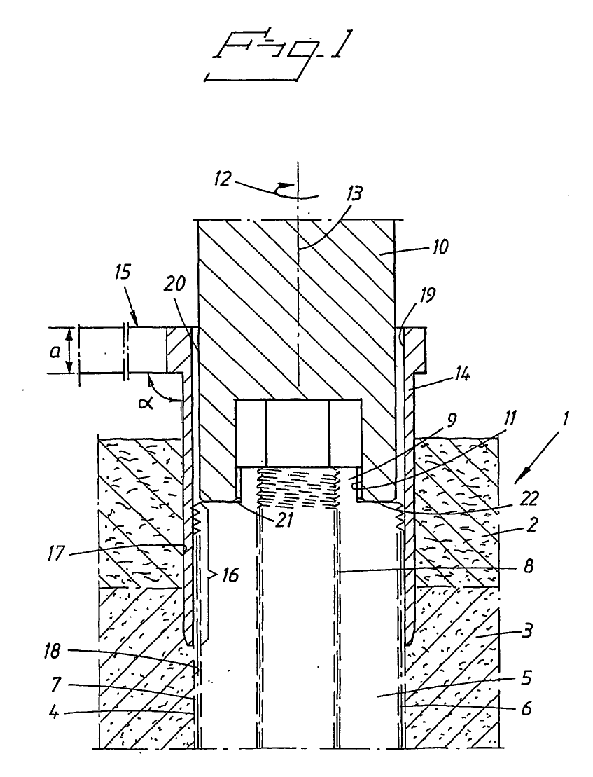

FIG. 1 shows a vertical section through the sleeve with actuating member in cooperation with upper parts of the implant, and application of a tightening tool via the sleeve,

FIG. 2 shows a horizontal section of the sleeve with maneuvering member according to FIG. 1, the tightening tool also having been illustrated,

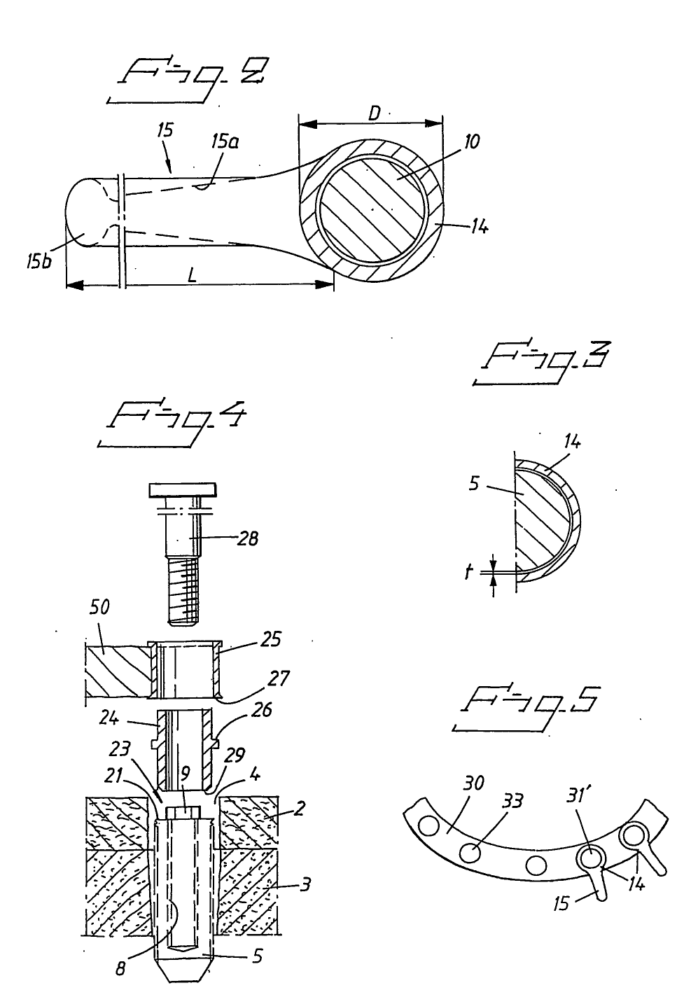

FIG. 3 shows in cross section the clearance between the outer surface of the implant and the inner surface of the sleeve,

FIG. 4 is an exploded view and vertical section showing an example of a set of components in an installation for an implant in a jaw bone,

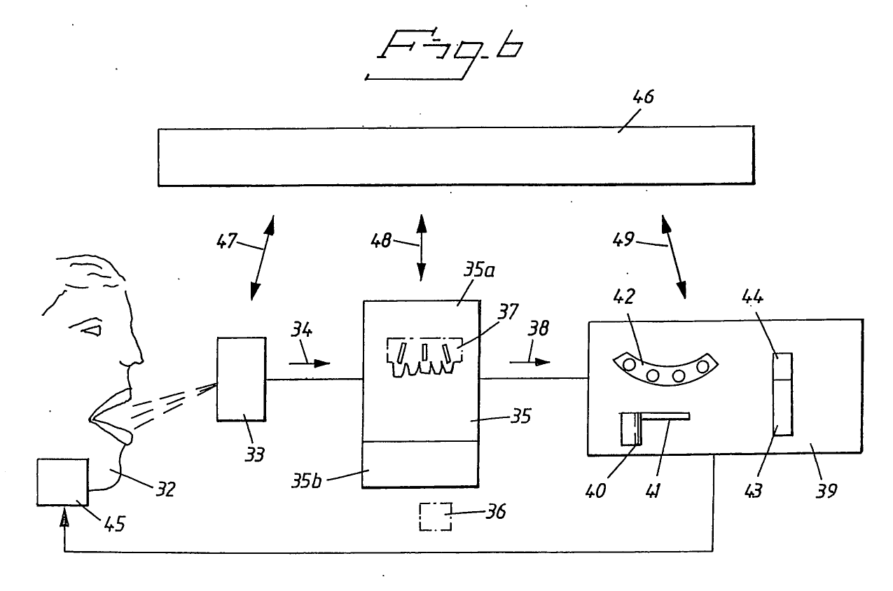

FIG. 5 is a horizontal view showing implant sites in a jaw bone, for example an upper jaw bone, and

FIG. 6 is a block diagram showing equipment included in a system.

In FIG. 1, a jaw bone, e.g. an upper jaw bone, is indicated symbolically by 1. The gum of the jaw bone is indicated by 2, and the actual dentine by 3. A hole 4 has been formed in the jaw bone and thus extends through both the gum and the dentine. An implant 5 with an outer thread 6 is screwed into the hole. This thread can cooperate with a thread formation 7 formed in the hole 4. The implant can alternatively be of the self-tapping kind. The implant is provided with an internal thread 8 for a dental structure, which is described in more detail below. The implant is also provided with an upwardly projecting member 9 or a member which projects outward from the outer part of the implant and on its outside is formed as a polygon or is nut-shaped. A tool is indicated by 10 and has an internal surface 11 which corresponds to the outer shape of the member 9 so that the implant can be screwed into the hole by means of the tool 10 being rotated in the clockwise direction 12. The rotation takes place about the common longitudinal direction or center line 13 of the tool and implant. FIG. 1 also shows a sleeve 14 which is provided with a radially outwardly projecting grip 15. The grip can extend substantially at right angles from the sleeve in accordance with the right angle α in the figure. The grip can have a thickness a of about 2 mm, for example. The sleeve 14 can be engaged over the upper parts 16 of the implant, and the sleeve can be pushed down over the outer surface 7 in a space formed by the sleeve in relation to inner surface parts 17, 18 of the gum and dentine, respectively. At its upper parts 19, the sleeve 14 can constitute a support for the outer surface 20 of the tool. Upon screwing down of the implant, the sleeve 14 is first applied to the hole 4 with the aid of the actuating member 15, after which the implant is applied via its free end to the hole, and the tool is joined to the implant and driven. In this connection, the manual actuating member 15 serves as a guide means both for the implant and the tool. The tool can be pushed down to the implant which has a support surface 21 for the end surface 22 of the tool.

FIG. 2 shows the sleeve 14 and its actuating member 15 from above. In a first embodiment, the actuating member can have a substantially rectangular extent, as shown by solid lines. Alternatively, the tool can be designed with a slightly narrowing portion 15a which, at the free end, merges into a substantially ball-shaped part 15b. Other embodiments are possible. The grip part 15 can have a length L of ca. 15 mm. The diameter D of the sleeve can be of the order of 5.0, 5.2 or 5.4 mm.

FIG. 3 shows the clearance t which exists between the sleeve 14 and the implant 5. Said clearance can be chosen between 0.1 and 0.2 mm.

FIG. 4 shows the case where the implant 5 is screwed down to its final position in the hole 4 in the gum 2 and dentine 3. The sleeve 14 according to FIG. 1 has been removed, and the upper parts 23 of the implant can constitute contact parts for the actual installation. The latter has a spacer sleeve 24 and a guide sleeve 25. The guide sleeve is anchored in the superstructure material/dental bridge material. Said sleeves 24 and 25 are connected when the sleeve 14 is removed. Before the connection, the sleeve 14 is left in the position according to FIG. 1 until the moment when application of the sleeves 24 and 25 is to be started. If there is a prolonged time between the anchoring and installation stages, the upper parts 23 can be protected with the, sleeve 14. Said tightening of the implant cannot be done until the sleeve 14 has been applied. The grip 14 also gives an indication that the sleeve is still present and that it can remain so until the installation procedure is performed. During said time period, the sleeve 14 prevents accumulation of bacteria at said upper parts 23 of the implant. During installation, the sleeve 24 is applied over the member 9, and the sleeve 25 is engaged over the top part of the sleeve 24 until a mutual stop position defined by stop surfaces 26, 27 on the sleeve 24 and sleeve 25, respectively. When the sleeves 24 and 25 have been applied in this way to the implant at its upper parts, a retaining screw 28 can be driven into the sleeves 25, 24 to engage with the inner threaded recess 8 in the implant. A reliable seal is obtained between the surface 21 of the implant and the end surface 29 of the sleeve 24. This also applies to the interacting surfaces 26 and 27 of the sleeves 24 and 25. A reliable sealing function with respect to gum and dentine is guaranteed in this way.

FIG. 5 shows a diagrammatic representation of an upper jaw 30 in which a number of implants 31, for example five implants, are to be anchored in the installation of a first implant. The implants are installed one by one, and the installation is done in a predetermined sequence. Thus, for example, the implants 31 and 31′ can be installed first. When the anchoring of these implants has been completed, the sleeve 14 with associated actuating member 15 can remain during the installation of the remaining implants. FIG. 5 shows two implants 31′ which have been fully anchored together with sleeves, which have remained in place, and associated actuating members. These sleeves thus remain in place until the other implants have been anchored. The time period which can elapse between the first and last implant anchoring can be up to about 1 hour.

FIG. 6 shows a diagrammatic representation of a system permitting the above-described anchoring and installation. A patient is indicated by 32. Identification equipment 33 can be used to identify a treatment situation on the patient. This identification can be done in a manner known per se using known means and will therefore not be described in detail here. The identification results in information 34 being output from the equipment and received in a computer appliance 35. The latter can be provided in a conventional manner with a screen 35a and operating element 35b. The operating element can be a keyboard. As a function of the information 34, the computer appliance can interact with a user 36 to visually present the dental structure for the actual treatment situation. The structure can consist of a dental bridge 37, and the screen is also able to show the upper jaw, implant positions and the shape of the dental bridge. The computer appliance can generate information 38, for example in the form of a CAD file, which is transferred to the equipment 39 for producing, on the one hand, the abovementioned sleeve 40 with associated actuating member 41 (cf. 14 and 15 in FIG. 2), and, on the other hand, the number of implants 42 and the structure on the implant 43 with associated member 44 (cf. FIG. 4). The dental bridge 37 can also be produced in the equipment 39. In the present case, this has been assumed to be based on manual work. The dental bridge, implant, sleeve 40, 41 are transferred to the patient treatment situation 45 for application in accordance with the above. Highly automated equipment 46 can be used, for example of the PROCERA® type. The fully automatic system for production of different products can be in communication with the various appliances according to FIG. 6. Thus, for example, the system 6 can communicate with the identification equipment 33, cf. the two-direction arrows 47 which indicate two-way communication. Correspondingly, communication can take place during production with computer equipment, see two-direction arrows 48. Finally, cooperation can exist between the appliances 39 and 46, cf. two-direction arrows 49. The main system can provide information concerning the solution of the treatment situation, the choice of dental bridge, implant, sleeve 40, 41, etc. The appliance 46 can also take part in the performance of one or more of said function steps. The communication can be by wire or can be wireless, for example via the public communication networks or telecommunications and computer communications (e.g. Internet). In FIG. 4, a dental structure is symbolized by 50. The computer equipment can operate with conventional programs and file management.

The invention is not limited to the embodiment described above by way of example, and instead it can be modified within the scope of the attached patent claims and the inventive concept.

1. An arrangement for installation of a dental structure, the arrangement comprising:
a dental implant being designed to be recessed in a hole and including an anti-rotational member;
a tightening tool which has a first member configured to engage the anti-rotational member of the dental implant; and
a sleeve comprising a handle and configured actuating to engage with slight clearance upper parts of the implant and wherein the tightening tool is designed to be applied so as to cooperate with the implant via the sleeve, and wherein, after completed anchoring of the implant and removal of the tightening tool, the sleeve can be removed with the handle to make room for application of members included in the installation.

2. The arrangement as in claim 1, wherein the sleeve and the handle removed after a period of time after anchoring the dental implant.

3. The arrangement as in claim 1, wherein the clearance is in the range of about 0.1-0.2 mm.

4. The arrangement as in claim 1, wherein the members included in the installation comprise a spacer sleeve that can be applied over the second member on the implant, and a guide sleeve which can be arranged relative to the spacer sleeve (24).

5. The arrangement as in claim 1, wherein the handle comprises an outwardly projecting grip part.

6. (canceled)

7. The arrangement as in claim 1, wherein the sleeve serves as guide member for the tightening tool

8. The arrangement as in claim 1, wherein the sleeve protects the upper contact surfaces of the implant to prevent accumulation of bacteria on the surfaces in conjunction with the anchoring and transition to the installation.

9. The arrangement as in claim 1, wherein the handle starting from the sleeve provided with actuating member, a substantially uniform width and/or uniform thickness.

10. The arrangement. as in claim 1, wherein the handle extends from the sleeve provided with the handle at a substantially right angle (α).

11. A system for installation of a dental structure, comprising:
a dental implant being designed to be recessed in a hole a tightening tool which has first members which can cooperate with corresponding second members on the dental implant;
helical identification equipment arranged to identify a treatment situation on a patient; and
transfer information dependent on the identified situation to a computer appliance, wherein the computer appliance in turn is arranged to determine, as a function of the received information, the structure and the anchoring of the respective implant with a sleeve which is provided with one or more actuating members and which can be engaged with slight clearance over upper parts of the implant with the aid of said actuating member or actuating members, and indicate, on the one hand, that the sleeve provided with actuating member is to be arranged to permit application of the tightening tool for cooperation with the implant via its inner parts, or that the sleeve is to be arranged to be removed with the actuating member or actuating members in order to leave room for application of members included in the installation.
